(19) United States
(12) Patent Application Publication
(10) Pub. No.: US 2007/0140106 A1
(43) Pub. Date: Jun. 21, 2007

(54) SYNCHRONIZATION CHANNEL FOR OFDMA BASED EVOLVED UTRA DOWNLINK

(75) Inventors: Yingming Tsai, Boonton, NJ (US); Guodong Zhang, Farmingdale, NY (US); Jung-Lin Pan, Selden, NY (US); Fatih M. Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/611,510

(22) Filed: Dec. 15, 2006

Related U.S. Application Data
(60) Provisional application No. 60/752,317, filed on Dec. 21, 2005.
(60) Provisional application No. 60/765,421, filed on Feb. 3, 2006.

(51) Int. Cl. H04J 11/00; H04J 3/06

(52) U.S. Cl. 370/208; 370/503

(57) ABSTRACT

A method for performing cell search in an orthogonal frequency division multiple access (OFDMA) based cellular communication network in which a primary synchronization channel (P-SCH), and optionally a secondary synchronization channel (S-SCH), carries cell search information. A downlink signal is received containing P-SCH symbols. The P-SCH symbols are processed to obtain an initial detection of frame timing, orthogonal frequency division multiplexing (OFDM) symbol timing, a cell identifier (ID), a frequency offset, and a cell transmission bandwidth. Optionally, an OFDM symbol timing self-check and error correction is then performed.

CROSS REFERENCE TO RELATED APPLICATIONS

This application claims the benefit of U.S. Provisional Application No. 60/752,317 filed Dec. 21, 2005 and U.S. Provisional Application No. 60/765,421 filed Feb. 3, 2006, which are incorporated by reference as if fully set forth.

### FIELD OF INVENTION

The present invention is related to a wireless communication system. More particularly, the present invention is related to a synchronization channel (SCH) for evolved universal terrestrial radio access (E-UTRA) downlink transmissions and corresponding cell search procedures.

### BACKGROUND

The long term evolution (LTE) of wideband code division multiple access (WCDMA) Third Generation Partnership Project (3GPP) cellular networks describes universal mobile telecommunications systems (UMTS) beyond 3GPP Release 7. LTE is also sometimes described by E-UTRA. In order to keep third generation (3G) technology competitive, both 3GPP and 3GPP2 are considering LTE, in which evolution of radio interface and network architecture is necessary.

Currently, orthogonal frequency division multiple access (OFDMA) is being considered for the downlink of E-UTRA. When a wireless transmit/receive unit (WTRU) is powered up, (i.e., activated), in an evolved universal terrestrial radio access network (E-UTRAN) where the downlink is OFDMA based, the WTRU must synchronize the frequency, frame timing and the fast Fourier transform (FFT) symbol timing with the (best) cell, and determine the cell identifier (ID). This process is called cell search.

FIG. 1 shows a downlink SCH 105 with a 1.25 MHz bandwidth occupied by two (2) 0.625 MHz tones T1 and T2. The same SCH 105 is mapped to the central portion of all of the system transmission bandwidths, (e.g., 20 MHz, 15 MHz, 10 MHz, 5 MHz, 2.5 MHz and 1.25 MHZ). As shown in FIG. 2, a downlink SCH 110 with a 5 MHz bandwidth occupied by eight (8) 0.625 MHz tones T1-T8 is mapped to the central portion of system transmission bandwidths of 5 MHz and above, (e.g., 20 MHz, 15 MHz, 10 MHz and 5 MHz), and an SCH 105 with a 1.25 MHz bandwidth occupied by two tones T1 and T2 is mapped to the central portion of system transmission bandwidths less than 5 MHz, (e.g., 2.5 MHz and 1.25 MHZ). Each tone has a bandwidth of approximately 0.625 MHz and represents a particular number of carriers.

The SCH and cell search process for OFDMA-based downlink are currently being studied in E-UTRA. It would be desirable to define a synchronization channel that is common for all cells in the system. Cell search procedures for E-UTRA preferably cause a small delay, result in satisfactory cell search performance, minimize system overload, and require low computational complexity.

Therefore, an appropriate synchronization channel and a corresponding cell search procedure for use in E-UTRA are desired.

### SUMMARY

In an OFDMA based system, a cell search method uses a primary synchronization channel (P-SCH) and optionally a secondary synchronization channel (S-SCH). Depending on the mapping scheme to each system transmission bandwidth, the P-SCH will use the same number of subcarriers for all possible bandwidths, or a different number of subcarriers according to the available P-SCH bandwidth centered within the system transmission bandwidth. A P-SCH symbol is transmitted at least one time during one radio frame. When several symbols are sent in one frame, then there can be either an equal time interval between symbols or an unequal time interval between symbols.

P-SCH symbols are processed to obtain initial detection of framing timing, orthogonal frequency division multiplexing (OFDM) symbol timing, cell ID, frequency offset and bandwidth. Optionally, a self check and correction of an OFDM symbol timing error is performed.

In one embodiment, polyphase codes with time reversal properties are preferably used to generate synchronization symbols. In an alternative embodiment, multiple synchronization channels are disclosed for enhancing cell search performance.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional synchronization channel that is independent of the available system bandwidth, defined for 1.25 MHz and centered in the middle of the available bandwidth;

FIG. 2 shows a conventional synchronization channel that is independent of the available system bandwidth, defined for 5 MHz and centered in the middle of the available bandwidth;

FIG. 3 shows how a P-SCH symbol is generated using a cell specific pseudorandom code sequence in accordance with the present invention;

FIG. 4 shows a frame format with equal intervals between P-SCH symbols in accordance with the present invention;

FIG. 5 shows a frame format with unequal intervals between P-SCH symbols in accordance with the present invention;

FIG. 6 is a method flowchart for preliminary cell search signal processing in accordance with the present invention;

FIG. 7 is a method flowchart for cell identifier (ID) detection and OFDM symbol timing self-check and correction during cell search in accordance with the present invention;

FIG. 8 shows how a primary synchronization channel (P-SCH) symbol is generated using a common pseudorandom code sequence used by all cells/sectors in accordance with the present invention;

FIG. 9 shows the frequency domain implementation of the synchronization symbol in accordance with a preferred embodiment of the present invention in accordance with the present invention;

FIG. 10 shows a time domain format of a synchronization symbol with simple repetition in accordance with the present invention;

FIG. 11 shows a time domain format of a synchronization symbol with center-symmetric properties in accordance with the present invention;

FIG. 12 shows sector cells where two synchronization symbols per frame use different subcarrier mapping patterns in accordance with the present invention; and

FIG. 13 shows sector cells deployment with the same subcarrier mapping pattern used in each synchronization symbol in accordance with the present invention.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

The present invention applies to the physical layer in a radio access communication network. Furthermore, the invention relates to the radio interface and the digital baseband subsystem of a wireless communication system.

The present invention is related to a synchronization channel and corresponding cell search procedures for E-UTRA. WTRUs process synchronization symbols to acquire frequency and time synchronization. A P-SCH enables at least the initial acquisition of symbol timing.

In a first embodiment of the present invention, it is possible that only one or more P-SCH symbols is transmitted. The P-SCH implicitly carries cell information such as cell ID. The WTRU can process P-SCH symbols to obtain OFDM symbol timing, frame timing, cell ID and other information. If the P-SCH is designed in such a way that the WTRU can detect the number of transmit antennas at the cell site, then the system does not have to transmit S-SCH symbols at all. Otherwise, one or more S-SCH symbols carrying information about a number of antennas will be transmitted.

Pseudorandom code sequences are preferably used to build synchronization symbols for P-SCH. The pseudorandom code sequences used by the present invention include, but are not limited to, generalized chirp-like (GCL), Zadoff-Chu, Frank, Golay, and Barker codes. A cell/sector specific code sequence will be used to implicitly carry cell ID information on the P-SCH or mitigate the intercell interference on the P-SCH.

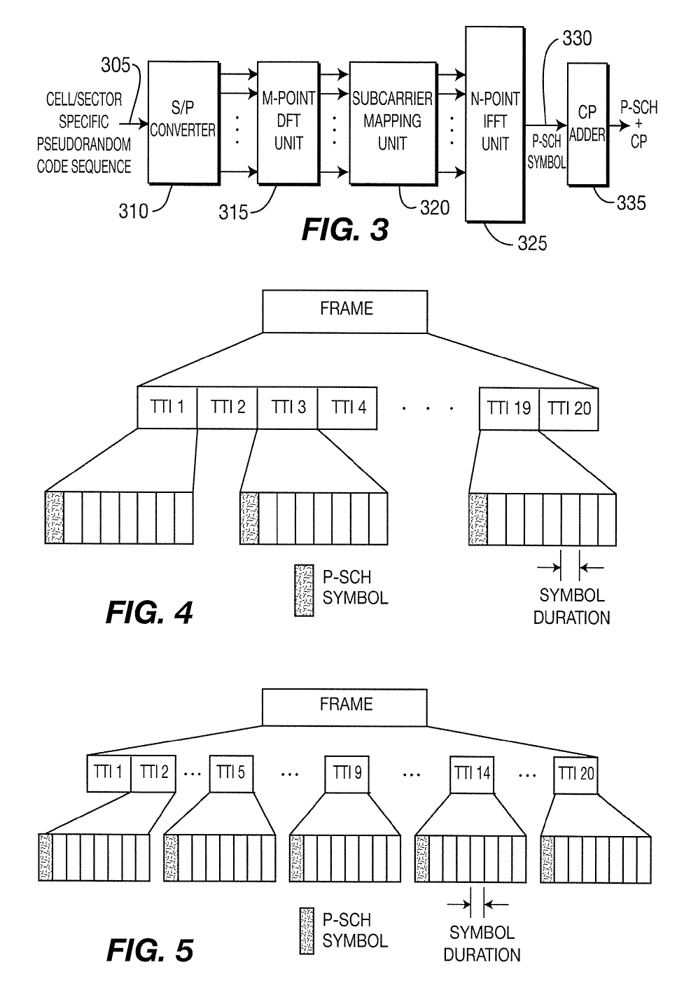

FIG. 3 shows how a P-SCH symbol is generated using a cell specific pseudorandom code sequence in accordance with the present invention. A pseudorandom code sequence 305 is fed into an M-point discrete Fourier transform (DFT) unit 315 via a serial to parallel (S/P) converter 310. The outputs of the DFT unit 315 are mapped by a subcarrier mapping unit 320 to the center chunk of subcarriers of the synchronization symbol. An N-point interpolated fast Fourier transform (IFFT) is performed on outputs of the subcarrier mapping unit 320 by an N-point IFFT unit 325 to generate a P-SCH symbol 330. A cyclic prefix (CP) adder 335 adds a CP to the P-SCH symbol 330 before transmission. In this way, the P-SCH has a low peak-to-average power ratio (PAPR), which is desirable for cell search performance.

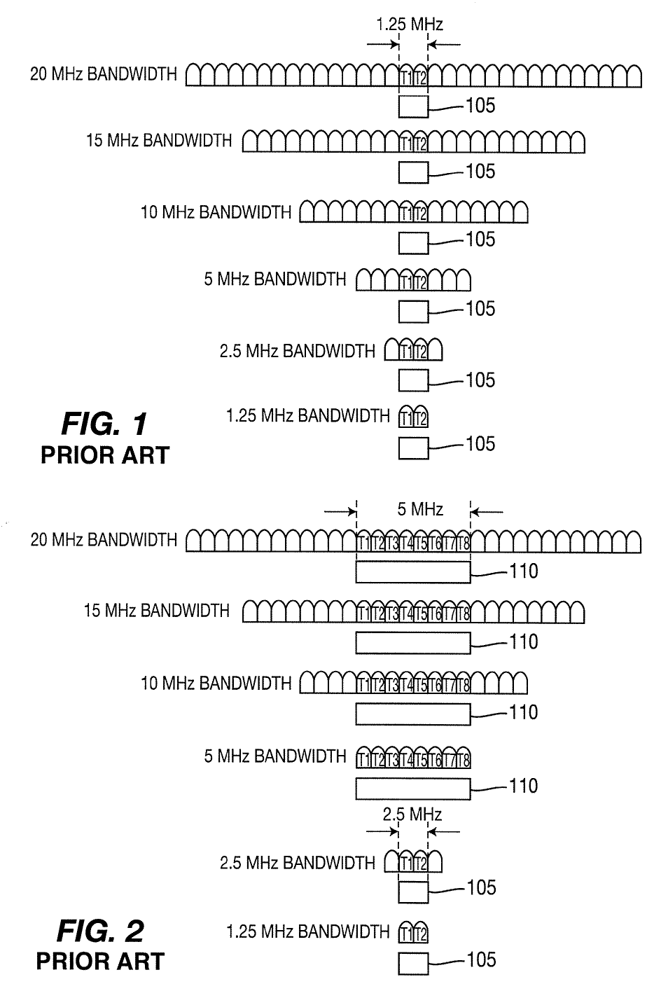

Depending on the bandwidth of the cell, the number of points of DFT and IFFT may be different for different cell bandwidths. If the P-SCH is mapped to the central 1.25 MHZ and 5 MHZ portions of the system transmission bandwidth, regardless of the transmission bandwidth of the system as shown in FIG. 1, then the P-SCH will use the same number of subcarriers for all possible bandwidths of the system. Exemplary parameters associated with the P-SCH in this scenario are shown below in Table 1.

TABLE 1

| | Transmission BW | | | | | |
|---|---|---|---|---|---|---|
| | 1.25 | 2.5 | 5 | 10 | 15 | 20 |
| | MHz | MHz | MHz | MHz | MHz | MHz |
| IFFT size (N) | 128 | 256 | 512 | 1024 | 1536 | 2048 |
| Number of available | 76 | 151 | 301 | 601 | 901 | 1201 |
| subcarriers | | | | | | |
| Number of | 64 | 64 | 64 | 64 | 64 | 64 |
| subcarriers used for | | | | | | |
| P-SCH (M) | | | | | | |

If the P-SCH is mapped to the central 1.25 MHZ and 5 MHZ portions of the system transmission bandwidths, as shown in FIG. 2, then P-SCH will use the different number of subcarriers correspondingly. Exemplary parameters of the P-SCH in this case are shown below in Table 2.

TABLE 2

| | Transmission BW | | | | | |
|---|---|---|---|---|---|---|
| | 1.25 | 2.5 | 5 | 10 | 15 | 20 |
| | MHz | MHz | MHz | MHz | MHz | MHz |
| IFFT size (N) | 128 | 256 | 512 | 1024 | 1536 | 2048 |
| Number of | 76 | 151 | 301 | 601 | 901 | 1201 |
| available | | | | | | |
| subcarriers | | | | | | |
| Number of | 64 | 64 | 256 | 256 | 256 | 256 |
| subcarriers used | | | | | | |
| for P-SCH (M) | | | | | | |

If the number of subcarriers used by the P-SCH is less than the number of available subcarriers, those subcarriers not used by the P-SCH will be set with zeros or carry user data.

Several possible frame formats are proposed by the present invention. Basically, the P-SCH symbol should be transmitted one or several times during one radio frame (of length 10 ms). If there are several P-SCH symbols in one radio frame, there can be equal or unequal intervals between P-SCH symbols. Compared to equal intervals, unequal intervals between P-SCH symbols may help the WTRU to better locate a frame boundary.

An exemplary frame format of P-SCH symbols with equal time intervals is shown in FIG. 4. For example, the interval between two P-SCH symbols in FIG. 4 is always 2 TTIs or sub-frames.

An exemplary frame format of P-SCH symbols with unequal time intervals is shown in FIG. 5. For example, the unequal time intervals between P-SCH symbols are 3,4,5 and 6 respectively. P-SCH and S-SCH symbols may be placed in other positions in a sub-frame other than the positions shown in FIGS. 4 and 5.

The proposed cell search method includes processing one or more P-SCH symbols and, optionally, one or more S-SCH symbols, to obtain frame timing, OFDM symbol timing, cell ID, frequency offset, bandwidth and the like. A self-check procedure is performed, and any existing OFDM symbol timing errors are corrected.

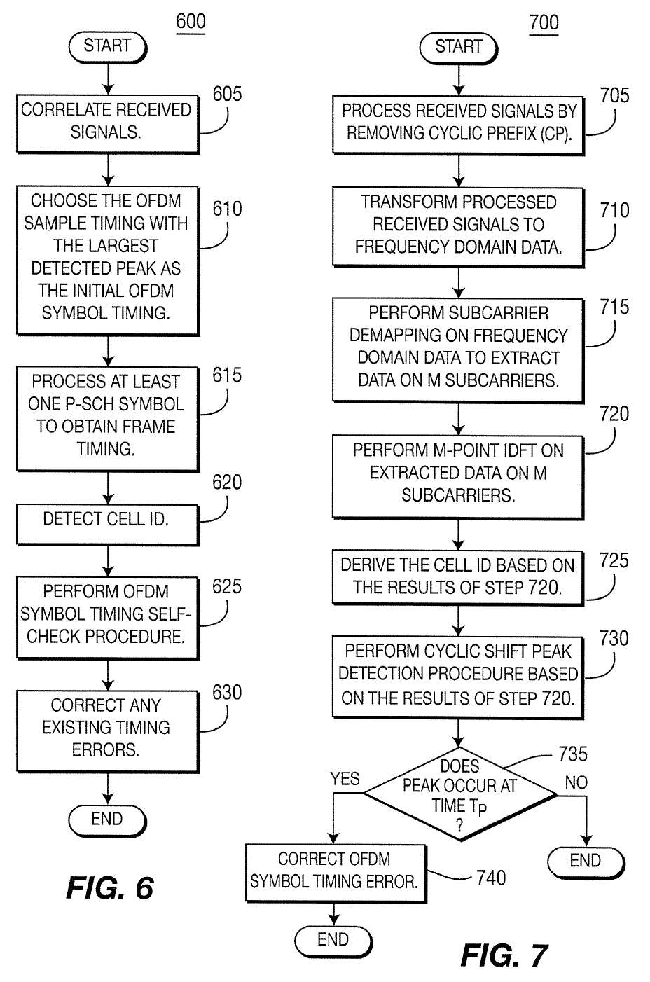

An example of initial detection of frame timing, OFDM symbol timing and other information is performed by a process 600 shown in FIG. 6. The P-SCH symbol is processed first to obtain initial OFDM symbol timing and frame timing.

FIG. 6 is a flowchart of a method 600 for performing preliminary cell search signal processing. In step 605, received signals are correlated. In step 610, the OFDM sample timing with the largest detected peak is chosen as the initial OFDM symbol timing. Depending on the number of P-SCH symbols in the radio frame and (equal or unequal) intervals between them, one or several P-SCH symbols may be processed in order to obtain the frame timing (step 615). After the frame timing is obtained, Cell ID may be detected by further processing of the received signals (step 620). Furthermore, the OFDM symbol timing obtained above may have errors. The proposed P-SCH symbol structure allows an OFDM symbol timing self-check procedure to be performed, such that any existing timing errors may be corrected (step 625). In step 630, any existing timing errors are corrected.

FIG. 7 is a flowchart of a method 700 for performing cell identifier (ID) detection and OFDM symbol timing self-check and correction during cell search. In step 705, received signals are processed by removing a cyclic prefix (CP). In step 710, the processed received signals are transformed to frequency domain data. In step 715, subcarrier demapping is performed on the frequency domain data to extract data on M subcarriers. In step 720, an M-point inverse discrete Fourier transform (IDFT) is performed on the M subcarriers to obtain detected synchronization sequence(s). In step 725, the cell ID is derived based the results of step 720. In step 730, a cyclic shift peak detection procedure is performed based on the results of step 720. If, in step 735, the peak occurs at time Tₚ, then there is an OFDM symbol timing error, Tₚ, which is corrected in step 740. Tp is a relative measure of the true downlink timing and the detected downlink timing, (by cell search). Otherwise, the process 700 ends if the peak does not occur at time Tₚ.

In accordance with another embodiment of the present invention, a WTRU can process one or more P-SCH symbols to obtain OFDM symbol timing, frame timing and other information. In this embodiment, the P-SCH does not carry cell information, such as the cell ID. Therefore, the WTRU needs to process the S-SCH symbols to obtain information such as cell ID.

Pseudorandom code sequences are used to build synchronization symbols for the P-SCH. The pseudorandom code sequences may be Zadoff-Chu codes, Golay codes, Barker codes and the like. A common code sequence will be used for all cells/sectors.

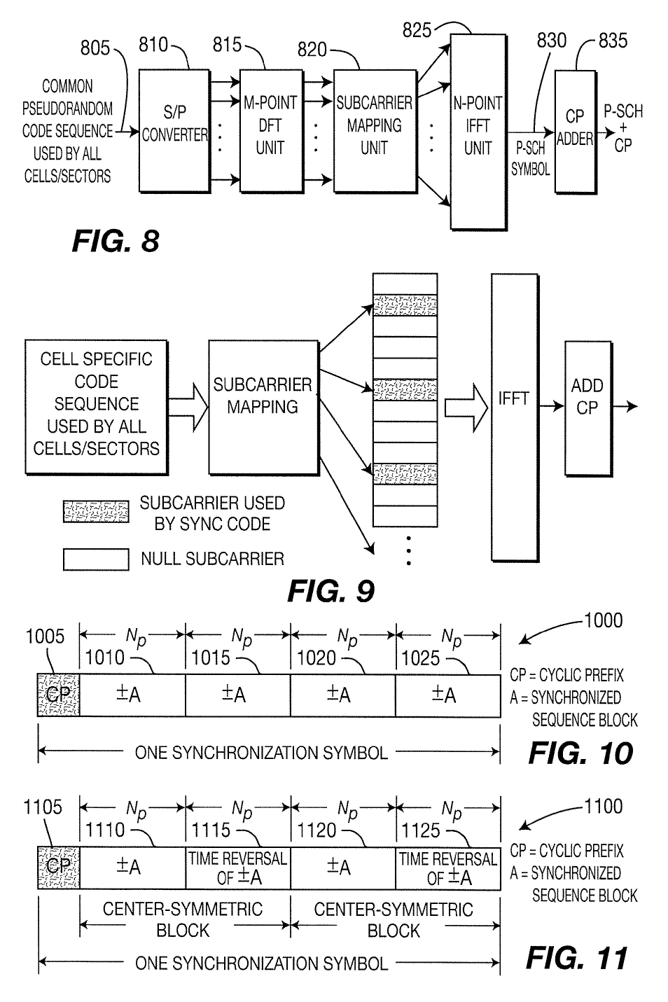

FIG. 8 shows how a P-SCH symbol is generated using a common pseudorandom code sequence used by all cells/sectors. Each common pseudorandom code sequence 805 is fed into an M-point DFT unit 815 via an S/P converter 810. The outputs of DFT unit 815 are mapped by a subcarrier mapping unit 820 to equal-distant subcarriers of the synchronization symbol. An N-point interpolated fast Fourier transform (IFFT) is performed on outputs of the subcarrier mapping unit 320 by an N-point IFFT unit 325 to generate a P-SCH symbol 830. A CP adder 835 adds a CP to the P-SCH symbol 830 before transmission. In this way, the P-SCH has a low PAPR, which is desirable for cell search performance.

Depending on the bandwidth of the cell, the number of points of DFT and IFFT may be different. If P-SCH is mapped to the central 1.25 MHz of the system transmission bandwidth as shown in FIG. 1, then the P-SCH will use the same number of subcarriers for all possible bandwidths of the system. Example parameters of the P-SCH in this case are shown in Table 1 of the first embodiment.

If P-SCH is mapped to the central 1.25 MHz and 5.0 MHz of the system transmission bandwidth as shown in FIG. 2, then the P-SCH will use the different number of subcarriers correspondingly. Example parameters of the P-SCH in this case are shown in Table 2 of the first embodiment.

If the number of subcarriers used by the P-SCH is less than the number of available subcarriers, subcarriers not used by the P-SCH will be put zeros or carry user data.

Several possible methods of P-SCH symbol mapping within a frame for the second embodiment are proposed. Basically, the P-SCH symbol should be transmitted one or several times during one radio frame, (of length 10 ms), and the S-SCH symbol may be transmitted, (optional, depending on the conditions described earlier), one or several times during one radio frame. The number of P-SCH and S-SCH symbols may not be the same. S-SCH symbol(s) should be transmitted after P-SCH symbol(s). If there are several P-SCH symbols in one radio frame, there can be equal or unequal intervals between P-SCH symbols. Compared to equal intervals, unequal intervals between P-SCH symbols may help the WTRU to better locate a frame boundary. Although P-SCH symbols are placed in the first OFDM symbol of a sub-frame in FIGS. 4 and 5, P-SCH symbols can be placed in the first OFDM symbol of a sub-frame as well.

The cell search method according to the second embodiment of the present invention will now be described. The P-SCH symbol is processed first to obtain initial OFDM symbol timing and frame timing in the same way as the first embodiment. The difference is that cell ID information cannot be obtained by processing of P-SCH symbol. The OFDM symbol timing obtained above may have errors. The proposed P-SCH symbol structure allows self-check and correction of timing errors in the same manner as previously described.

The present invention may be implemented in a WTRU, base station, network or system, at the physical layer (radio/digital baseband), as a digital signal processor (DSP) or application specific integrated circuit (ASIC). The present invention is applicable to 3GPP long term evolution (LTE) based communication air interfaces. Although the present invention has been described in reference to evolved UTRA or LTE, the method can also be readily applied to any OFDMA based system.

In accordance with another embodiment of the present invention, synchronization symbol(s) that implicitly carry information of cell/sector ID (or cell/sector group index) are utilized. Potentially, pseudorandom code sequences with zero auto correlation, (for example, GCL code, Zadoff-Chu code, Polyphase code and the like), are used to build synchronization symbols. Alternatively, cell-specific codes can be used to implicitly carry information such as cell/sector ID. In the frequency domain, the synchronization sequence, (i.e., code sequence), is mapped to equal-spaced subcarriers. The preferred distance between subcarriers used by one synchronization symbol is four subcarriers. That is, if a subcarrier s is used by the SCH, then subcarriers s+4, s+8, and so on, are used as well. Therefore, for one synchronization symbol there are four non-overlapping subcarrier mapping patterns, namely 1, 2, 3 and 4, respectively.

Referring to FIG. 9, the frequency domain implementation of the synchronization symbol format of the present invention is shown.

FIG. 10 shows a synchronization symbol in the time domain contains four blocks 1010, 1015, 1020 and 1025 of equal length Nₚ, each block containing a synchronization sequence A. A cyclic prefix (CP) is attached at the beginning of a synchronization symbol 1000. The second block 1015, the third block 1020 and the fourth block 1025 are repetitions of the first block 1010. Alternatively, as also shown in FIG. 10, the second block 1015, the third block 1020 and the fourth block 1025 may be sign reversed. For the P-SCH symbol used in a system (or cell), the polarity of the blocks will always be fixed. For example, the transmitted P-SCH symbol is always A; —A; A; and A.

In another embodiment shown in FIG. 11, polyphase codes with time reversal properties may be used to generate a synchronization symbol 1100. In this embodiment, the synchronization symbol 1100 in the time domain contains four blocks 1110, 1115, 1120 and 1125 of equal length Nₚ, and a CP 1105 is attached at the beginning of the synchronization symbol 1100. Each block 1100, 1115, 1120 and 1125 contains a synchronization sequence of length Nₚ. The third block 1120 is the (possibly sign inverted) repetition of the first block 1110. The second block 1115 and the fourth block 1125 are the (possibly sign inverted and/or conjugate) time reversal of the first block 1110 and the third block 1120 respectively. Accordingly, the first block 1110 and the second block 1115 together can be regarded as one longer “center-symmetric block”, as shown in FIG. 11. The same holds for the third and fourth blocks. Compared to the repetitive blocks as shown in FIG. 10, center-symmetric blocks can reduce the side-lobes of correlation.

There are several possible formats of time reversal. For the first and second blocks, the synchronization sequence A contained in one block has the following property:
A(k)=±A(2Nₚ+1−k), k=1, 2, . . . , Nₚ, Equation (1)
or
A(k)=±(A(2Nₚ+1−k)*, k=1, 2, . . . , Nₚ, Equation (2)
where ( )* is the conjugate operator. Similarly for the third and fourth blocks, the synchronization sequence A contained in one block has the following property:
A(k)=±A(4Nₚ+1−k), k=2Nₚ+1, 2Nₚ+2, . . . , 3Nₚ, Equation (3)
A(k)=±(A(4Nₚ+1−k))*, k=2Nₚ+1, 2Nₚ+2, . . . , 3Nₚ. Equation (4)
Both synchronization symbol formats in FIGS. 10 and 11 allow performing simple (time domain) differential correlation at the WTRU to acquire time and frequency synchronization.

Depending on the bandwidth of the cell, the number of subcarriers used by a synchronization symbol may be the same or different for different cell bandwidths. For example, a synchronization symbol is mapped to the central 1.25 MHz of the bandwidth regardless of the transmission bandwidth of the system, as shown in FIG. 1. The synchronization channel will use the same number of subcarriers for all possible bandwidths of the system. If the number of subcarriers used by the synchronization channel is less than the number of available subcarriers, the subcarriers not used by the synchronization channel will be set to zero or carry user data.

K synchronization symbols should be transmitted per radio frame (10 msec), where K is a design parameter whose value is preferably larger than one in order to obtain good cell search performance in a reasonably short time. Those K synchronization symbols can be transmitted concatenated or separated in time. When synchronization symbols are transmitted separated in time, equal-distance between symbols is preferred, making it easier for the receiver to combine the received synchronization symbols.

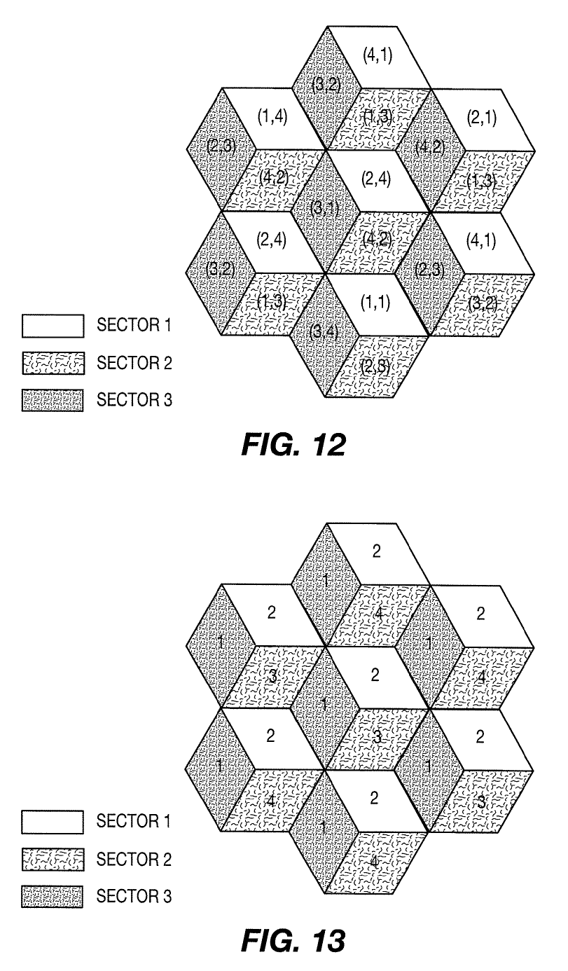

If the synchronization channel in accordance with the embodiments of the present invention as described above cannot carry all the information a WTRU needs for synchronization, then an S-SCH may be required. Where an S-SCH is required, a fixed timing should exist between the P-SCH and the S-SCH.

Where both a P-SCH and an S-SCH are utilized, subcarrier mapping patterns Mᵢ(p) is applied to the i^{th} synchronization symbol of cell p. It should be noted that it is possible that Mᵢ(p)=Mⱼ(p) for i≠j. In another embodiment of the invention, for each synchronization symbol, different (non-overlapping) subcarrier mapping patterns are used at neighboring cells/sectors. That is, for cells p and q (p≠q) and each synchronization symbol i, Mᵢ(p)≠Mᵢ(q). In this way, interference of synchronization symbols from neighboring cells/sectors may be reduced, which in turn improves cell search performance. An example of this embodiment is shown in FIG. 12, where K=2. It should be noted that in FIG. 12, the value of K is chosen as K=2 purely for convenience of illustration. The set (m, n) in each sector in FIG. 12 denotes the subcarrier mapping patterns used in the first and second synchronization symbols of a frame in a cell/sector. A cell site has 3 sectors which provide 120 degrees of directional coverage.

In yet another embodiment, it is possible that all synchronization symbols in one frame use the same subcarrier mapping pattern. One example is shown in FIG. 13. The index m in each sector in FIG. 13 denotes the subcarrier mapping patterns used in all synchronization symbols in a cell/sector.

Let Cᵢ(p) denote the code used in the ith synchronization symbol of cell/sector p. It should be noted that it is possible that Cᵢ(p) =Cⱼ(p) for i≠j. Since more than one synchronization symbol (i.e. K>1) is transmitted per radio frame, combined code indices (and potentially mapping patterns as well) are used to implicitly carry cell/sector ID information. In this way, the number of cell/sector IDs that can be represented by the synchronization symbols is increased remarkably.

The cell/sector ID of cell/sector p can be mapped to the combination of code indices used in the K synchronization symbols. As depicted by Equation (5) below:
Cell_IDₚ=f(C₁(p), C₂(p), . . . , C_{K}(p)). Equation (5)

Alternatively, the cell/sector ID of cell/sector p can be mapped to the combination of code indices and mapping patterns used in the K synchronization symbols. As depicted by Equation (6) below:
Cell_IDₚ=f(C₁(p), C₂(p), . . . , C_{K}(p), M₁(p), M₂(p), . . . , M_{K}(p)). Equation (6)
In this way, a large number of cell/sector indices can be supported by the synchronization channel. For example, seventy-six (76) subcarriers in the center can be used for purposes of synchronization and K=2 synchronization symbols are transmitted per radio frame. Since an equal-spaced subcarrier mapping with distance of four subcarriers is used, pseudorandom codes with length of 19 will be used for synchronization symbols. The number of cell/sector indices that can be supported is 361 if the cell/sector ID of cell/sector p is mapped to the combination of code indices used in the two synchronization symbols. For the K>2 case, cell/sector ID can be mapped to the combination of code indices in a similar way.

Where an S-SCH is used, S-SCHs of different sectors are preferably transmitted on different subcarriers to avoid, (or mitigate), the intercell interference on S-SCHs. For each sector, equal-distant subcarriers are preferably used for the S-SCH. The distance is preferably equal to the number of sectors. For example, the distance between subcarriers used for the S-SCH is three in a cell site with three sectors. Alternatively, a pre-defined mapping between subcarrier positions of S-SCH and cell/sector ID, (or just the code index used by P-SCH symbols), may be used. Hence, once the WTRU detects the cell/sector ID, it knows the subcarriers' positions to receive the S-SCH.

The present invention may be implemented in a UE, a base station, and generally in a wireless communication network or system comprising both a WTRU and a base station. The present invention may also be implemented in an application specific integrated circuit (ASIC), or a digital signal processor.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller, or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of performing cell search in an orthogonal frequency division multiple access (OFDMA) based system in which a primary synchronization channel (P-SCH) carries cell search information, the method comprising:
receiving a downlink signal containing P-SCH symbols; and
processing the P-SCH symbols to obtain cell search information that includes at least one of an initial detection of frame timing, an orthogonal frequency division multiplexing (OFDM) symbol timing, a cell identifier (ID), a frequency offset, and a cell transmission bandwidth.

2. The method of claim 1 further comprising:
performing a self-check and correction of any OFDM symbol timing error.

3. The method of claim 1, wherein the OFDM symbol timing and the initial detection of frame timing includes:
correlating the received downlink signal;
detecting a peak OFDM sample; and
selecting an initial OFDM symbol timing point corresponding to the detected peak OFDM sample.

4. The method of claim 2, wherein the self-check and correction of any OFDM symbol timing error includes:
removing a cyclic prefix from the received downlink signal;
transforming the received downlink signal to frequency domain data;
performing subcarrier demapping on the frequency domain data to extract data on M subcarriers;
performing an M-point inverse discrete Fourier transform (IDFT) on the extracted data to generate results;
detecting an OFDM symbol timing error based on the results; and
correcting the OFDM symbol timing error.

5. The method of claim 4 further comprising:
performing a cyclic shift peak detection based on the results;
determining presence of an OFDM symbol timing error if cyclic shift peak occurs at time Tₚ greater than zero; and
defining the OFDM symbol timing error equal to time Tₚ.

6. The method of claim 4 further comprising:
deriving a cell identifier (ID) based on the results.

7. The method of claim 1, wherein a network entity forms the downlink signal containing the P-SCH, the method further comprising:
forming a synchronization symbol for the P-SCH using a pseudorandom code sequence.

8. The method of claim 7, wherein the pseudorandom code sequence is specific to a cell.

9. The method of claim 8, wherein the cell is defined by cell sectors, in which the pseudorandom code sequence is specific to each cell sector.

10. The method of claim 1 further comprising:
forming a synchronization symbol for the P-SCH using a pseudorandom code sequence common to all cells in the OFDM based system.

11. The method of claim 1, wherein each cell in the OFDM based system is defined by a plurality of cell sectors, the method further comprising:
forming a synchronization symbol for the P-SCH using a pseudorandom code sequence common to all cell sectors.

12. The method of claim 6, wherein the cell ID is obtained from a secondary synchronization channel in the downlink signal.

13. The method of claim 7, wherein the pseudorandom code sequence is a Zadoff-Chu code.

14. The method of claim 7, wherein the pseudorandom code sequence is a Golay code.

15. The method of claim 7, wherein the pseudorandom code sequence is a Barker code.

16. The method of claim 7 further comprising:
processing the pseudorandom code sequence using a discrete Fourier transform (DFT) process; and
mapping the DFT outputs to a center chunk of subcarriers of the synchronization symbol.

17. The method of claim 16 further comprising:
adding a cyclic prefix to the synchronization symbol.

18. The method of claim 16, wherein the same number of subcarriers are used by the P-SCH for all possible system transmission bandwidths.

19. The method of claim 18, wherein the P-SCH is mapped to a single bandwidth for all possible system transmission bandwidths.

20. The method of claim 18, wherein the P-SCH is mapped to a bandwidth of 1.25 MHz centered within the cell transmission bandwidth.

21. The method of claim 16, wherein a different number of subcarriers are used by the P-SCH for respective system transmission bandwidths.

22. The method of claim 21, wherein the P-SCH is mapped to a plurality of fixed bandwidths for all possible system transmission bandwidths.

23. The method of claim 21, wherein the P-SCH is mapped to a bandwidth of either 1.25 MHz or 5 MHz centered within the cell transmission bandwidth.

24. The method of claim 1, wherein several P-SCH symbols are transmitted per radio frame, and there are equal intervals between the P-SCH symbols.

25. The method of claim 1, wherein several P-SCH symbols are transmitted per radio frame, and there are unequal intervals between the P-SCH symbols.

26. A wireless transmit/receive unit (WTRU) configured to perform a cell search in accordance with the method of claim 1.

27. A base station configured to form a synchronization symbol for the P-SCH in accordance with the method of claim 7.

28. In a wireless communication system including at least one wireless transmit/receive unit (WTRU) and at least one base station, a method for performing an initial cell search, the method comprising:
the base station transmitting a primary synchronization channel including synchronization symbols implicitly carrying cell or sector identification information.

29. The method of claim 28 further comprising:
the WTRU receiving the primary synchronization channel.

30. The method of claim 28 wherein the synchronization symbols are pseudorandom code sequences.

31. The method of claim 30, wherein the pseudorandom code sequences have zero auto-correlation properties.

32. The method of claim 31, wherein the pseudorandom code sequences are selected from the following group of sequences: generalized chirp-like (GCL) code, Zadoff-Chu code, and Polyphase code.

33. The method of claim 28, wherein the synchronization symbols form a synchronization sequence.

34. The method of claim 33, wherein the synchronization sequence is mapped to equal-spaced frequency domain subcarriers.

35. The method of claim 33, wherein the preferred distance between subcarriers of a synchronization symbol is four subcarriers.

36. The method of claim 33, wherein the synchronization symbols are of equal length in time domain.

37. The method of claim 33, wherein a cyclic prefix is attached at the beginning of the synchronization symbols.

38. The method of claim 37, wherein the synchronization symbols contain a first block, a second block, a third block and a fourth block of equal lengths.

39. The method of claim 38, wherein the second, third, and fourth blocks are repetitions of the first block.

40. The method of claim 38, wherein the any of the second, third, or fourth blocks are sign reversed repetitions of the first block.

41. The method of claim 28, wherein polyphase codes are used for the synchronization symbols.

42. The method of claim 38, wherein the third block is a repetition of the first block.

43. The method of claim 38, wherein the third block is the sign inverted time reversal of the first block.

44. The method of claim 42, wherein the third block is a conjugate time reversal of the first block.

45. The method of claim 38, wherein the fourth block is a repetition of the second block.

46. The method of claim 42, wherein the fourth block is a sign inverted time reversal of the second block.

47. The method of claim 38, wherein the fourth block is a conjugate time reversal of the second block.

48. The method of claim 38 further comprising:
the WTRU performing a simple differential correlation on the synchronization sequence to acquire time and frequency synchronization.

49. The method of claim 28 further comprising:
mapping the synchronization symbols to the central portion of the bandwidth regardless of the of the transmission bandwidth of the network.

50. The method of claim 28, wherein the number of synchronization symbols that are transmitted by a base station is greater than the number of symbols required to obtain good cell search performance in a short time period.

51. The method of claim 28 further comprising:
the base station transmitting a secondary synchronization channel (S-SCH).

52. The method of claim 51 further comprising:
the WTRU receiving the S-SCH.
